(19) United States
(12) Patent Application Publication
(10) Pub. No.: US 2005/0056735 A1
(43) Pub. Date: Mar. 17, 2005

(54) Easy slide conduit system and method

(76) Inventor: Dale Fedewa, Phoenix, AZ (US)

Correspondence Address: SNELL & WILMER;ONE ARIZONA CENTER, 400 EAST VAN BUREN, PHOENIX, AZ, 850040001, US

(21) Appl. No.: 10/803,525

(22) Filed: Mar. 17, 2004

Related U.S. Application Data
(60) Provisional application No. 60/493,620, filed on Aug. 7, 2003.

(51) Int. Cl. F16L 5/00

(52) U.S. Cl. 248/56

(57) ABSTRACT

An EASY SLIDE conduit management system. The system enables conduit, piping, or the like to be partially or fully secured to a building or other type of structure. The system includes a series of one or more channel supports having openings contained therein and retaining elements configured to secure the conduit, pipe, or the like within the openings. The system facilitates the quick and efficient installation and control of conduit in most commercial, retail, industrial, residential, and other environments.

### CROSS REFERENCE TO RELATED APPLICATIONS

This application claims priority to, and the benefit of, U.S. Provisional patent application entitled “Quick Clip Conduit System and Method” filed on Aug. 7, 2003 and assigned U.S. Ser. No. 60/493620, the entire contents of which are hereby incorporated by reference.

### FIELD OF INVENTION

This application generally relates to a conduit management system. The present invention facilitates the installation and management of conduit, piping and the like with minimal or no tooling.

### BACKGROUND OF THE INVENTION

In the commercial, industrial, and/or residential building setting, a multitude of conduit piping is used to channel utility lines such as electrical wiring throughout. It is a current practice in the construction industry to use a multi-part conduit securing system. These systems use a plurality of braces and clamps to secure the conduit in place. The disadvantages of these systems are that they require a significant amount of labor to install along with a multitude of separate braces, clamps and tools. In typical fashion, an installer must first install the numerous brackets to accept the conduit piping. Next, as the conduit piping is installed, he must secure the piping with clamps and fasteners. In this setting, the installer must make at least two trips, one to install the brackets and a second to secure the conduit with clamps as the conduit is installed. Additionally, the installer must constantly have an adequate supply of clamps on hand to secure the conduit. The present invention provides for an easy, efficient manner to install and secure conduit, piping and the like. In an effort to manage a conduit system in an organized fashion, the present invention is presented and herein described below.

The present invention is directed to an efficient conduit management system that requires minimal tooling and significantly less labor than existing conduit securing systems. The conduit management system of the present invention includes support brackets having a self-locking/securing mechanism, which retain the conduit in a static position, thereby preventing excessive motion or rattling. The support brackets are easily installed at regular intervals to support the conduit. Furthermore, the brackets are readily installed in any manner to accept conduit running in either a vertical or horizontal direction.

### SUMMARY OF THE INVENTION

In general, the “Easy Slide Conduit System and Method,” (herein after “EASY SLIDE conduit system”) is a conduit management system. The conduit may include a pipe, building material or any other component, which may be partially or fully secured by the present invention. In one embodiment, the invention includes a series of one or more support channels and self-locking clips configured to facilitate the quick and efficient installation and control of conduit in most commercial, retail, industrial, residential, and other environments. The present invention facilitates the installation and management of conduit, piping, and the like with minimal or no tooling. The present invention also reduces both material and labor costs in almost any installation.

More particularly, and as more fully disclosed in the attached drawings and figures, the support channels may be mounted substantially or fully perpendicular to the pipe as the pipe is passed through the channels. The self-locking clip may be partially or fully engaged to substantially “lock” or secure the pipe to minimize or restrict the pipe from sliding, rattling or any other type of directional movement or change. Using the present invention, the conduit may be permanently or temporarily mounted horizontally for ceilings and floors and/or vertically for wall applications. The support channels may include any pattern of openings, and in one exemplary embodiment, a versatile pattern having five openings is repeatable every foot and can be custom fit on the job site. The channels are substantially “j” or “c” shaped channels that, in this exemplary embodiment, may be approximately three to six inches wide and one to ten feet long. The channels have a pattern of five extruded openings approximately every foot, with spring clips to engage, secure, and/or lock the conduit. In one embodiment, the channel material may be 16 gauge galvanized steel.

The exemplary clips may include any device that substantially or partially secures the conduit in the opening such as, for example, by applying pressure against the conduit and/or limiting movement of the conduit. In one embodiment, the clips include spring steel, self-locking clips of any suitable shape. The clips are configured to be “riveted” on the support channel at each extruded opening, and may deform to an angle such that the pressure of the spring steel may lock or secure the conduit into place. The clips may permanently or temporarily secure the conduit, thereby allowing for easy adjustment of the conduit during installation or at a later time.

### BRIEF DESCRIPTION OF THE DRAWINGS

A more complete understanding of the present invention may be derived by referring to the detailed description and claims when considered in connection with the figures, where like reference numbers refer to similar elements throughout the figures, and

FIG. 1 depicts a perspective view of the EASY SLIDE conduit system illustrating an exemplary embodiment of the present invention;

FIG. 2A depicts an end view of the EASY SLIDE conduit system illustrating an exemplary embodiment of the present invention used in conjunction with a section of conduit piping to display the utility of the invention.

FIG. 2B depicts an end view of the EASY SLIDE conduit system, illustrating an exemplary embodiment of the present invention used in conjunction with a section of conduit piping, and displaying an optional bolt that may be used to further secure the conduit.

FIG. 3 depicts a second embodiment of the EASY SLIDE conduit system showing cutout features contained within the openings that are used to secure the conduit.

### DETAILED DESCRIPTION OF EXEMPLARY EMBODIMENTS

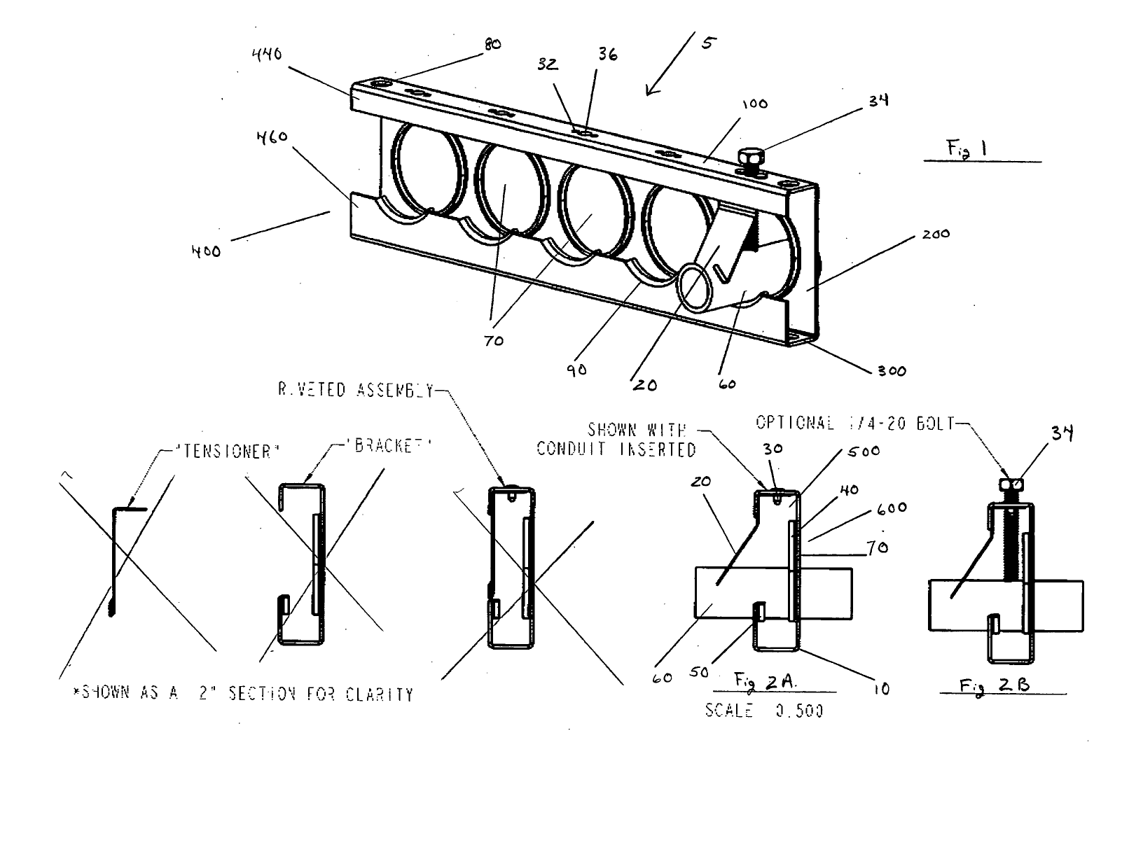

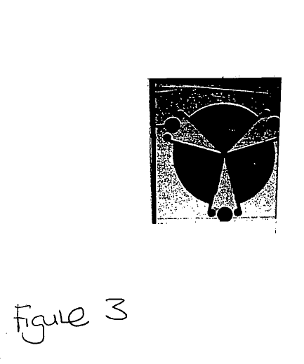

Turning now to the drawings that depict the presently preferred embodiments of the invention for the purpose of illustrating the practice thereof, and not by way of limitation of the scope of the invention, note that like reference characters refer to corresponding elements throughout the views. FIGS. 1 and 2A illustrate the EASY SLIDE conduit system generally indicated by reference character 5 and described herein below. FIG. 2B illustrates the EASY SLIDE conduit system generally illustrated by FIG. 2A, but further illustrating optional bolt 34 that may be used to further secure the conduit. FIG. 3 illustrates a second exemplary embodiment of the EASY SLIDE conduit system.

In one embodiment, EASY SLIDE conduit system 5 comprises a substantially “j” shaped channel and is best viewed by the side view shown in FIGS. 2A and 2B, reference character 10. “J” shaped channel 10 may comprise a single piece of material formed to define an inner area 500 and outer area 600. Moreover, as shown in FIG. 1, the channel may delineate a top portion 100, a back portion 200, a bottom portion 300 and a front portion 400. The front portion 400 may comprise an upper front portion 440 and a lower front portion 460. “J” shaped channel 10 may be formed by any means which allows the material comprising the channel to be formed into the exemplary “j” configuration. Such means may include hot or cold extrusion, drawing, bending, and the like. The material for the channel may comprise 16 gauge galvanized steel, however any material may be used which is capable of carrying out the function of the EASY SLIDE conduit system.

In a continuing exemplary embodiment of the present invention, “j” shaped channel 10 may be affixed with a spring steel component (spring clip) 20 to the inner, top portion of the “j” shaped channel using rivets 30. Rivets 30 are threaded through apertures 32 located in top portion 100 of “j” shaped channel 10 to affix spring clip 20 to “j” shaped channel 10. As shown by example in FIG. 2A, this configuration allows a conduit or pipe 60 to be secured within an opening 70 contained in “j” shaped channel 10 by deforming spring clip 20 to an angle where the yield point is not yet achieved but where the residual stress retained by the spring clip material forces conduit 60 into a static position against the top edge of lower front portion 460 of “j” shaped channel 10. It will be appreciated by those skilled in the art that spring clip 20 may be affixed to “j” shaped channel 10 by any means that secures spring clip 20 into place such as spot welding, screws, adhesives, clamps and the like.

In a continuing exemplary embodiment of the present invention, and depicted by FIG. 2B, the EASY SLIDE conduit system may further employ an optional bolt 34 threaded through an aperture 36 in top portion 100 to further secure conduit 60 against the top edge of lower front portion 460 of “j” shaped channel 10.

In the exemplary embodiment described herein and depicted by the figures, the invention is described as utilizing a generally “j” shaped channel design. However, it should be appreciated by those skilled in the art that any shaped design configuration may be used to perform a similar function, such as for example, a “c” shaped channel configuration, rounded or elongated tubing, and the like.

Further, “j” shaped channel 10 includes a plurality of openings 70 to accept conduit 60 as it passes through back portion 200 of “j” shaped channel 10. Openings 70 are spaced apart equidistantly from one another and are of an adequate diameter to allow conduit 60 to pass there through. In one exemplary embodiment, openings 70 are situated in a pattern of five openings grouped together, which is then repeated approximately every foot. It will be appreciated by those skilled in the art that openings 70 may comprise any regular or irregular shape configuration such as squares, triangles, ovals, rectangles, polygons and the like. Moreover, the openings 70 may be spaced in any configuration or pattern to facilitate management of a conduit system

As shown in FIG. 2A, opening 70 may be surrounded about its perimeter on the inner area 500 of “j” shaped channel 10 by a support lip 40. Support lip 40 may be used to further support conduit 60 as it passes through “j” shaped channel 10 and facilitates installation of the conduit within the system. An extrusion process or any process capable of producing support lip 40 may form lip 40. Moreover, a second support lip 50 may be positioned on the inner area of lower front portion 460 of “j” shaped channel 10 as shown in FIG. 2A.

In conjunction with support lip 50, including a conduit forming cutout 90 on lower front portion 460 of “j” shaped channel 10 may provide further conduit support. The cutout 90 may be designed to conform to the external, perimeter contour of the conduit thereby further securing the conduit in place and further restricting the movement of the conduit. It should be appreciated by those skilled in the art that any configuration may be used for cutout 90 and that it is not limited in design to only the contour of the conduit.

In another aspect of the exemplary embodiment, retention of the conduit within the EASY SLIDE conduit system may be provided by using cutouts within opening 70 instead of, or in conjunction with, spring clip 20. In “cutting out” the openings, a patterned cutout may be used such that material remains connected to the “j” shaped channel 10, and this material could function in a similar fashion as the spring clips to secure the conduit in place. For example, the cutout pattern could allow for the remaining, connected material to bend and deform, thereby holding the conduit in place. This configuration of openings is best shown in FIG. 3.

In an exemplary embodiment of the present invention, “j” shaped channel 10 further comprises screw holes 80 for attaching conduit system 5 to building members such as ceiling joists, floor boards, support beams and the like. Screw holes 80 as shown, are situated at either end of top portion 100 of “j” shaped channel 10 but may be situated in any regular or irregular interval. Further, screw holes 80 may be of any size to allow for adequate attachment capabilities. For example, design or building configurations may require screw holes to be positioned in bottom portion 300 of “j” shaped channel 10, back portion 200 of “j” shaped channel 10, etc.

In the above description, the invention is described as a system to manage conduit. It should be appreciated though, that the present invention may be used in the described or a modified manner to manage any member that requires affixation at discrete intervals to restrict movement of such member. Such members may include, for example, plumbing members, co-axial cables, and the like.

In the foregoing specification, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of the present invention.

1. A conduit management system comprising:
at least one channel support member;
at least one opening contained within the channel support member for retaining one or more conduits; and
at least one retaining member positioned near the opening for restricting movement of the conduit within the opening.

2. The conduit management system of claim 1 wherein the retaining member comprises a clip member attached to the channel support member.

3. The conduit management system of claim 1 wherein the retaining member comprises an element having a residual pattern formed by cutting the opening in the channel support member.

4. The conduit management system of claim 1 further comprising at least one aperture in the channel support member for attaching the retaining member to the channel support member.

5. The conduit management system of claim 1 further comprising a support lip extending from at least a portion of a perimeter of the opening in the channel support member.

6. The conduit management system of claim 1 further comprising at least one screw hole contained in the channel support member for securing the conduit system to at least a portion of a building.

7. The conduit management system of claim 1 wherein the channel support member comprises a “j” shaped or “c” shaped configuration.

8. The conduit management system of claim 1 wherein the openings are spaced apart equidistantly from one another.

9. The conduit management system of claim 1 wherein the channel support member includes multiple groups of five openings grouped together that are spaced approximately one foot apart.

10. The conduit management system of claim 1 wherein the channel support member is comprised of at least one of a metal, a plastic, a composite.

11. The conduit management system of claim 1 wherein the retaining member is comprised of at least one of a spring metal, a flexible plastic, a rubber, or a flexible composite.

12. A method for managing conduit comprising:
providing at least one channel support member;
providing at least one opening contained within the channel support member for retaining one or more conduits; and
providing at least one retaining member positioned near the opening for restricting movement of the conduit within the opening.

13. The method of claim 12, wherein said step of providing at least one channel support member comprises providing a “j” shaped or a “c” shaped channel support member.

14. The method of claim 12, wherein said step of providing at least one retaining member positioned near the opening for restricting movement of the conduit within the opening comprises providing an element having a residual pattern formed by cutting the opening in the channel support member.

15. The method of claim 12, wherein said step of providing at least one opening contained within the channel support member comprises providing multiple groups of five openings on said channel support member which are grouped together and spaced approximately one foot apart.

16. The method of claim 12, wherein said step of providing at least one retaining member positioned near the opening for restricting movement of the conduit within the opening comprises,
providing a retaining member comprising at least one of a of spring metal, a flexible plastic, a rubber, and a flexible composite material.

17. The method of claim 12, wherein said step of providing at least one channel support member comprises providing at least one screw hole contained in said channel support member for securing the conduit system to at least a portion of a building.

18. The method of claim 12, where said step of providing at least one retaining member positioned near the opening for restricting movement of the conduit within the opening comprises providing a clip member attached to the channel support member.
